(19) United States
(12) Patent Application Publication
(10) Pub. No.: US 2023/0357574 A1
(43) Pub. Date: Nov. 9, 2023

(54) FIXING TREATMENT COMPOSITION AND METHOD OF USING THE SAME

(71) Applicant: CRAYOLA LLC, EASTON, PA (US)

(72) Inventors: JANE PATRIARCA, HELLERTOWN, PA (US); BRITTNEY PRICE, BETHLEHEM (KS); ZACH YOUNG, WIND GAP, PA (US)

(21) Appl. No.: 18/142,719

(22) Filed: May 3, 2023

Related U.S. Application Data
(60) Provisional application No. 63/337,770, filed on May 3, 2022.

(51) Int. Cl. C09B 67/20; D06P 1/52; D06P 1/651

(52) U.S. Cl. CPC C09B 67/0063; D06P 1/525; D06P 1/5228; D06P 1/65131

(57) ABSTRACT

The various aspects of the invention described herein relate to a fixing treatment composition, a method of making the same, a permanent marking system including the same, and a method of using a fixing treatment composition (including but not necessarily limited to the fixing treatment composition of the present invention) to permanently affix one or more inks to a substrate. The various aspects of the invention leave room for error in the application of markers and dyes to substrates and can be used to create permanent designs that will not wash out of said substrates (e.g., fabric).

### CROSS-REFERENCE TO RELATED APPLICATIONS

This application is based on and claims priority to U.S. Provisional Application Ser. No. 63/337,770, filed on May 3, 2022, which is incorporated herein by reference in its entirety.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

### 1. Field of the Invention

The present invention relates generally to fixing treatment compositions that can be used to permanently affix ink to substrates and methods of creating permanent artwork on fabric.

### 2. Description of Related Art

Fabric markers and dyes are typically permanent such that they cannot be washed or rinsed from fabrics, leaving little room for error in their application to create designs or patterns. For this reason, if they are exposed to an undesired portion of a given fabric, there is no opportunity to remove them and try again, and it is often necessary to start the process over again with new fabric. Accordingly, it can be both challenging and costly to create desirable designs on fabric utilizing traditional fabric markers and dyes, particularly for individuals who are inexperienced and/or who are not professional fabric painters or textile artists.

In view of these challenges, inks that are washable and/or rinsable could be used to create designs on fabric. In this way, if undesirable designs are created, the fabric can simply be rinsed and/or washed to remove the ink. However, one significant downside associated with using inks that are at least partially rinsable and/or partially washable is that—if desirable designs are created—the fabric cannot be rinsed and/or washed without partially or entirely removing the designs. Thus, inks that are at least partially rinsable and/or partially washable are not ideal for creating designs on fabric that is routinely washed and/or cleaned (e.g., t-shirts, jeans, etc.). Moreover, such ink is prone to transfer to other items and fabrics it comes into contact with and/or to run/bleed when exposed to the elements (e.g., rain, snow, etc.).

### BRIEF SUMMARY OF THE INVENTION

In an aspect, the present invention is directed to a fixing treatment composition that includes one or more acrylic binders, one or more film formers, and one or more diluents. In certain preferred embodiments, the fixing treatment composition further includes one or more rheology modifiers. In certain embodiments, the fixing treatment composition further includes one or more stain blockers. In certain embodiments, the fixing treatment composition further includes one or more surfactants. In certain embodiments, the fixing treatment composition further includes one or more tinting dyes. In certain embodiments, the fixing treatment further includes one or more preservatives.

Preferably, the fixing treatment composition includes: about 60 wt % to about 85 wt % of the one or more acrylic binders; about 2.5 wt % to about 15 wt % of the one or more film formers; and about 5 wt % to about 15 wt % of the one or more diluents. In certain embodiments that include one or more rheology modifiers, the concentration of the one or more rheology modifiers is preferably about 0.5 wt % to about 5 wt %. In certain embodiments that include one or more stain blockers, the concentration of the one or more stain blockers is preferably about 1 wt % to about 10 wt %. In certain embodiments that include one or more surfactants, the concentration of the one or more surfactants is preferably about 3 wt % or less.

Preferably, the one or more acrylic binders are one or more aqueous emulsion acrylic polymers. Preferably, the one or more aqueous emulsion acrylic polymers are JONCRYL® 646 (supplied by BASF), SC 6569 (supplied by StanChem), RHOPLEX™ AC-464 Emulsion Polymer (supplied by Dow Chemical), RHOPLEX™ AC-261LF Emulsion Polymer (supplied by Dow Chemical), ENCORE® 636 (supplied by Arkema) NEOCAR® ACRYLIC 820 (supplied by Arkema), DI18031-07 (supplied by Zschimmer & Schwarz), or combinations thereof.

Preferably, the one or more film formers are polyethylene glycol, polyvinyl pyrrolidone (PVP), polyvinyl acetate (PVA), ethylene-vinyl alcohol copolymer (EVOH), polyvinyl alcohol (PVOH), or combinations thereof. More preferably, the one or more film formers are one or more polyvinyl alcohols. Preferably, the one or more polyvinyl alcohols are hydrolyzed polyvinyl alcohols, partially hydrolyzed polyvinyl alcohols, or combinations thereof. More preferably, the one or more film formers are one or more partially hydrolyzed polyvinyl alcohols. Preferred partially hydrolyzed polyvinyl alcohols include Selvol™ Polyvinyl Alcohol 09-523 Solution (supplied by Sekisui Special Chemicals).

Preferably, the one or more diluents are propylene glycol, glycerin, propylene carbonate, ethylene glycol, diethylene glycol, triethylene glycol, or combinations thereof. More preferably, the one or more diluents are propylene glycol.

In certain embodiments of the fixing treatment composition that include one or more rheology modifiers, the one or more rheology modifiers may be inorganic, organic, non-ionic associative thickeners, anionic associative thickeners, non-associative thickeners, or combinations thereof. Preferably, the one or more rheology modifiers are SC 6477 (supplied by StanChem), ACRYSOL™ RM-2020 (supplied by Dow Chemical), or combinations thereof.

In certain embodiments of the fixing treatment composition that include one or more stain blockers, the one or more stain blockers are preferably sodium octane sulfonate, sodium xylene sulfonate, fatty alcohol ethoxylate, disodium hexadecyldiphenyloxide disulfonate, benzene-1,1-oxybis-tetrapropylene sulfonated sodium, decyl-sulfophenoxy-benzenesulfonic acid disodium, decyl-sulfophenoxybenzenesulfonic acid disodium, octylphenoxypolyethoxyethanol, sodium salt of naphthalene-formaldehyde condensation polymer, sodium salt of carboxylated polyelectrolytes, sodium lignin sulfonate, styrene maleic anhydride copolymers, Durablock SB (supplied by DURA Chemicals), or combinations thereof.

In certain embodiments of the fixing treatment composition that include one or more surfactants, the one or more surfactants are preferably acetylenic diols, acetylenic diol ethoxylates, alkylphenol ethoxylates, or combinations thereof. Preferably, the one or more surfactants are acetylenic diols.

In another aspect, the present invention is directed to a permanent marking system that includes the fixing treatment composition of the present invention and one or more inks. The inks are at least partially rinsable, at least partially washable, or combinations thereof. Preferably, the permanent marking system includes one or more brushes.

In yet another aspect, the present invention is directed to making the fixing treatment composition of the present invention. The method includes the following steps: adding a first portion of the one or more film formers to the one or more acrylic binders to form a mixture; and subsequently adding a first portion of the one or more diluents to the mixture. In certain preferred embodiments, the method further includes the following steps: subsequently adding a second portion of the one or more film formers to the mixture; and subsequently adding a second portion of the one or more diluents to the mixture. In certain preferred embodiments, the method further includes one or more of the following steps: adding one or more rheology modifiers to the mixture; adding one or more stain blockers to the mixture; and/or adding one or more surfactants to the mixture.

In yet one more aspect, the present invention is directed to a method of permanently affixing one or more inks to a substrate. The method includes the following steps: applying the one or more inks to a portion of the substrate; and applying a fixing treatment composition to the portion of the substrate. The one or more inks are at least partially rinsable, at least partially washable, or combinations thereof. Preferably, the method further includes one or more of the following steps: allowing the portion of the substrate to air dry; heating the portion of the substrate with a dryer; and/or ironing the portion of the substrate. In certain preferred embodiments, the method may be performed with the fixing treatment composition of the present invention. In certain preferred embodiments, the method may be performed with the permanent marking system of the present invention.

Additional aspects of the invention, together with the advantages and novel features appurtenant thereto, will be set forth in part in the description that follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 depicts t-shirt 10 with a star design 12 and a crescent moon design 14.

FIG. 2 depicts t-shirt 10 after portions of star design 12 and crescent moon design 14 are permanently affixed thereto.

FIG. 3 depicts a sectional view of t-shirt 20 with a star design 22 and a crescent moon design 24.

FIG. 4 depicts a sectional view of t-shirt 20 after portions of star design 22 and crescent moon design 24 are permanently affixed thereto.

FIG. 5 depicts a sectional view of t-shirt 20 after a second washing of t-shirt 20.

FIG. 6 depicts t-shirt 30 with the words LET IT GROW and a flower design 32.

FIG. 7 depicts t-shirt 30 after the word GROW and flower design 32 are permanently affixed thereto.

### DETAILED DESCRIPTION OF PREFERRED EMBODIMENT

The various aspects of the invention described herein relate to a fixing treatment composition, a method of making the same, a permanent marking system including the same, and a method of using a fixing treatment composition (including but not necessarily limited to the fixing treatment composition of the present invention) to permanently affix one or more inks to a substrate. The various aspects of the invention leave room for error in the application of markers and dyes to substrates and can be used to create permanent designs that will not wash out of said substrates (e.g., fabric).

The inks are preferably at least partially rinsable, at least partially washable, or combinations thereof. More preferably, the inks are rinsable, washable, or combinations thereof. Suitable washable and/or rinsable inks for use with the fixing treatment composition of the present invention include, but are not necessarily limited to, those described in U.S. Pat. No. 9,321,927, which is incorporated by reference in its entirety herein; and those contained in Crayola® Ultra-Clean™Washable Markers and Crayola® Washable Markers. Suitable partially rinsable and/or washable inks include, but are not necessarily limited to, those contained in Crayola® Markers. Suitable substrates include, but are not necessarily limited to, fabric (e.g., clothing), and preferably cotton fabric.

As used herein, an ink's “washability” refers to the removability of the ink from a surface (e.g., cotton fabric) with the use of water and a surfactant, such as a soap (e.g., laundry detergent). For example, an ink is “washable” from a surface if a user is able to remove colored “stains” created by the ink from the surface, particularly cotton fabric, by washing the surface with soap and water (e.g., by washing cotton fabric with soap and water, such as in a washing machine with water and laundry detergent). An ink is “at least partially washable” from a surface if a user is able to remove at least some of the ink that forms colored “stains” created by the ink from the surface, particularly cotton fabric, by washing the surface with soap and water (e.g., by washing cotton fabric with soap and water, such as in a washing machine with water and laundry detergent).

An ink's “rinsability” refers to the removability of the ink from a surface, such as cotton fabric, with the use of water only, such as a stream of running water or a wet sponge, and without the use of a surfactant (e.g., soap) or other cleaning agent. Thus, water that is used to rinse the ink from the surface does not contain an added surfactant or any other type of added cleaning agent. For example, an ink is “rinsable” from a surface if a user is able to remove colored “stains” created by the ink from the surface by washing the surface with water only. For example, a colored “stain” on cotton fabric may be rinsed by holding the cotton fabric under running water, by wiping the cotton fabric with a wet sponge, or by submerging the cotton fabric in water. In some cases, the stained portion of fabric is additionally scrubbed by hand while holding it under water.

An ink composition is “rinsable” if it can be entirely removed (i.e. is “entirely rinsable”), or substantially removed (i.e., is “substantially rinsable”), from the surface. The composition has been entirely removed from the surface if, after applying only water (e.g., after holding cotton fabric under running water, wiping the cotton fabric with a wet sponge, or submerging the cotton fabric in water, and in some cases after additionally scrubbing the “stained” portion of fabric by hand), the ink (e.g., a stain created by the ink) is no longer visible at all on the surface. The composition has been substantially removed from a surface if, after applying only water, the vast majority of the ink has been removed so that the ink (e.g., a stain created by the ink) is only slightly visible on the surface (i.e. only a very light, faded residue from the ink is still visible on a fabric surface). An ink is “at least partially rinsable” from a surface if, after applying only water, a user is able to remove at least some of the ink that forms colored “stains” created by, the ink from the surface, particularly cotton fabric.

As used herein, “cotton fabric” is preferably fabric that consists of 100% cotton. For example, the cotton fabric may comprise an item of clothing or an accessory that is 100% cotton, such as a shirt (e.g., a t-shirt), pair of pants, skirt, dress, sock, undergarment, hat, glove, jacket, or handbag. The fabric may alternatively be another type of article, such as a household item (e.g., a tablecloth or drapes). Cotton fabric may alternatively comprise a blend of cotton with another type of natural or synthetic fabric, such as nylon, polyester, rayon, silk, wool, or blends thereof (e.g., a blend of 50% cotton and 50% polyester, or 60% cotton and 40% polyester). As used herein, “fabric” (which is interchangeable with the term “cloth”) includes strands of natural and/or synthetic fibers (e.g., yarn and/or thread) that have been woven together (such as by weaving or knitting) so that they are interlaced.

In an aspect, the present invention is directed to a fixing treatment composition. The fixing treatment composition of the present invention is sometimes referred to herein as a “permanency gel.” The fixing treatment composition of the present invention includes one or more acrylic binders, one or more film formers, and one or more diluents.

The one or more acrylic binders or resins seal designs created on substrates with ink that is at least partially rinsable and/or at least partially washable by creating a water impervious barrier. Exemplary acrylic binders include, but are not necessarily limited to, aqueous emulsion acrylic polymers. Exemplary aqueous emulsion acrylic polymers include, but are not necessarily limited to: JONCRYL® 646 (supplied by BASF), SC 6569 (supplied by StanChem), RHOPLEX™ AC-464 Emulsion Polymer (supplied by Dow Chemical), RHOPLEX™ AC-261LF Emulsion Polymer (supplied by Dow Chemical), ENCORE® 636 (supplied by Arkema) NEOCAR® ACRYLIC 820 (supplied by Arkema), DI18031-07 (supplied by Zschimmer & Schwarz), or combinations thereof.

The one or more film formers provide overall flexibility to the one or more acrylic binders, thereby reducing and/or eliminating cracking of the one or more acrylic binders. Exemplary film formers include, but are not necessarily limited to, polyethylene glycol, polyvinyl pyrrolidone (PVP), polyvinyl acetate (PVA), ethylene-vinyl alcohol copolymer (EVOH), polyvinyl alcohol (PVOH), or combinations thereof. Other exemplary film formers may include the aforementioned exemplary film formers, water-soluble natural polymers, including, but not necessarily limited to, gums (e.g., xanthan gum, guar gum), starches/dextrins, or combinations thereof. Preferably, the film formers are polyvinyl alcohols. More preferably, the polyvinyl alcohols are hydrolyzed, partially hydrolyzed, or combinations thereof. Most preferably, the polyvinyl alcohols are partially hydrolyzed. Exemplary partially hydrolyzed polyvinyl alcohols include, but are not necessarily limited to, Selvol™ Polyvinyl Alcohol 09-523 Solution (supplied by Sekisui Special Chemicals), which is a 9 wt % solution in water.

The one or more diluents modify the viscosity of the fixing treatment composition, serve as humectants to prevent fixing treatment composition from drying out prematurely, and also provide freeze-thaw stability such that the fixing treatment composition will still work as intended after several cycles of freezing and thawing. Exemplary diluents include, but are not necessarily limited to, propylene glycol, glycerin, propylene carbonate, ethylene glycol, diethylene glycol, triethylene glycol, or combinations thereof. Preferably, the diluent is propylene glycol.

In certain embodiments, the fixing treatment composition of the present invention further includes one or more rheology modifiers or acrylic thickeners. Rheological properties (e.g., viscosity, flow behavior) of compositions may be adjusted by rheology modifiers. The one or more rheology modifiers or acrylic thickeners add body/viscosity to the fixing treatment composition to enhance its performance. Exemplary rheology modifiers include, but are not necessarily limited to, inorganic (e.g., clays and similar minerals), organic (e.g., polymers), non-ionic associative, anionic associative, non-associative thickeners, and combinations thereof. Exemplary non-ionic associative thickeners include, but are not necessarily limited to, hydrophobically modified ethylene oxide urethane (HEUR) and hydrophobically modified polyether (HMPE) thickeners. Exemplary anionic associative thickeners include, but are not necessarily limited to, hydrophobically modified alkali swellable emulsions (HASE). Exemplary non-associative thickeners include, but are not necessarily limited to, alkali swellable emulsions (ASE). Preferred rheology modifiers include, but are not necessarily limited to: SC 6477 (supplied by StanChem), ACRYSOL™ RM-2020 (supplied by Dow Chemical), or combinations thereof.

In certain embodiments, the fixing treatment composition of the present invention further includes one or more stain blockers. In the event water were to penetrate the fixing treatment composition after it is applied to a substrate to seal a design and after it is allowed to dry, solubilized ink may be released from the ink design and could potentially stain other portions of the substrate. In that circumstance, the one or more stain blockers can help to keep any released ink in a solubilized state, thereby preventing undesirable staining to other areas of the substrate. In other words, the one or more stain blockers serve to complex and trap any released dyes. Exemplary stain blockers include, but are not necessarily limited to, sodium octane sulfonate, sodium xylene sulfonate, fatty alcohol ethoxylate, disodium hexadecyldiphenyloxide disulfonate, benzene-1,1-oxybis-tetrapropylene sulfonated sodium, decyl-sulfophenoxy-benzenesulfonic acid-disodium, decyl-sulfophenoxybenzenesulfonic acid di sodium, octylphenoxypolyethoxyethanol, sodium salt of naphthalene-formaldehyde condensation polymer, sodium salt of carboxylated poly-electrolytes, sodium lignin sulfonate, styrene maleic anhydride copolymers, Durablock SB (supplied by DURA Chemicals), or combinations thereof.

In certain embodiments, the fixing treatment composition of the present invention further includes one or more surfactants, one or more tinting dyes, and/or one or more preservatives.

Surfactants may be used to promote wetting of the fabric by the fixing treatment composition. Exemplary surfactants include, but are not necessarily limited to, acetylenic diols and acetylenic diol ethoxylates available from Surfynol® and Dynol®; alkylphenol ethoxylates such as octylphenol ethoxylates and nonylphenol ethoxylates; or combinations thereof.

Tinting dyes may be used to add optional color to the area protected by the permanency gel. Exemplary tinting dyes include but are not necessarily limited to water-soluble dyes such as acid dyes, basic dyes, direct dyes, or combinations thereof.

Preservatives are used to prevent microbial growth in the permanency gel during storage. Suitable preservatives are those used as antimicrobial and/or antifungal agents.

In certain embodiments, the fixing treatment composition of the present invention includes glitter.

The concentration of the one or more acrylic binders in the fixing treatment composition is preferably about 60 wt % to about 85 wt %, more preferably about 70 wt % to about 82 wt %, and most preferably about 75 wt % to about 80 wt %.

The concentration of the one or more film formers in the fixing treatment composition is preferably about 2.5 wt % to about 15 wt %, more preferably about 4 wt % to about 12 wt %, and most preferably about 5 wt % to about 10 wt %.

The concentration of the one or more diluents in the fixing treatment composition is preferably about 5 wt % to about 15 wt %, more preferably about 7.5 wt % to about 12 wt %, and most preferably about 9 wt % to about 11 wt %.

In certain embodiments of the fixing treatment composition that include one or more rheology modifiers, the concentration of the one or more rheology modifiers in the fixing treatment composition is preferably about 0.5 wt % to about 5 wt %, more preferably about 0.75 wt % to about 4 wt %, and most preferably about 1 wt % to about 3 wt %.

In certain embodiments of the fixing treatment composition that include one or more stain blockers, the concentration of the one or more stain blockers in the fixing treatment composition is preferably about 1 wt % to about 10 wt %, more preferably about 2 wt % to about 8 wt %, and most preferably about 4 wt % to about 6 wt %.

In certain embodiments of the fixing treatment composition that include one or more surfactants, the concentration of the one or more surfactants in the fixing treatment composition is preferably about 3 wt % or less.

In certain embodiments of the fixing treatment composition that include one or more tinting dyes, the concentration of the one or more tinting dyes in the fixing treatment composition is preferably about 3 wt % or less.

In certain embodiments of the fixing treatment composition that include one or more preservatives, the concentration of the one or more preservatives in the fixing treatment composition is preferably about 2 wt % or less.

In certain embodiments of the fixing treatment composition that include glitter, the concentration of the glitter in the fixing treatment composition is preferably about 3 wt % or less.

Exemplary and non-limiting formulations of the fixing treatment composition of the present invention are set forth below in Table 1:

TABLE 1

| | | Weight percent (wt %) | | | | | | | | | |
|---|---|---|---|---|---|---|---|---|---|---|---|
| Ingredient | Function | 1 | 2 | 3 | 4 | 5 | 6 | 7 | 8 | 9 | 10 |
| RHOPLEX ™ AC-464 | Acrylic binder | 59.8 | 59.8 | 59.8 | 59.8 | 59.8 | 0 | 0 | 0 | 0 | 0 |
| Emulsion Polymer | | | | | | | | | | | |
| RHOPLEX ™ AC-261LF | Acrylic binder | 20.2 | 25.2 | 19.2 | 22.7 | 22.7 | 0 | 0 | 0 | 0 | 0 |
| Emulsion Polymer | | | | | | | | | | | |
| NEOCAR ® ACRYLIC 820 | Acrylic binder | 0 | 0 | 0 | 0 | 0 | 77 | 77 | 0 | 0 | 72 |
| DI18031-07 | Acrylic binder | 0 | 0 | 0 | 0 | 0 | 0 | 0 | 77 | 72 | 0 |
| Selvol ™ Polyvinyl | Film former | 10 | 5 | 10 | 5 | 5 | 10 | 10 | 10 | 10 | 10 |
| Alcohol 09-523 Solution | | | | | | | | | | | |
| Propylene Glycol | Diluent | 10 | 10 | 10 | 10 | 10 | 10 | 10 | 10 | 10 | 10 |
| SC 6477 | Rheology | 0 | 0 | 0 | 2.5 | 2.5 | 3 | 3 | 3 | 3 | 3 |
| | modifier | | | | | | | | | | |
| ACRYSOL ™ RM-2020 | Rheology | 0 | 0 | 1 | 0 | 0 | 0 | 0 | 0 | 0 | 0 |
| | modifier | | | | | | | | | | |
| Durablock SB | Stain blocker | 0 | 0 | 0 | 0 | 0 | 0 | 0 | 0 | 5 | 5 |

| | | | | | | | | | | |
|---|---|---|---|---|---|---|---|---|---|---|
| Total | 100 | 100 | 100 | 100 | 100 | 100 | 100 | 100 | 100 | 100 |

In another aspect, the present invention is directed to a permanent marking system. The permanent marking system includes: the fixing treatment of the present invention; and one or more inks that are at least partially rinsable, at least partially washable, or combinations thereof. The one or more inks can be used to make artistic creations of any kind, particularly when applied to a substrate, such as fabric. According to particular embodiments, the ink is contained inside a writing utensil, such as a marker or pen. Alternatively, the ink may be used as a paint. Thus, embodiments include a marker, a pen, or a paint that comprises the ink. In exemplary embodiments, a marker comprises the ink. For example, according to one embodiment, the permanent marking system of the present invention includes a plurality of markers, with each marker including an ink that is at least partially rinsable at least partially washable, or combinations thereof. Preferably, the composition contained in each marker is a different color. As used herein, a marker is a writing utensil that has an ink source and a tip made of porous or pressed fibers, such as felt (e.g., a felt-tipped pen). A marker may include a container (glass, aluminum or plastic) and a core of an absorbent material such as felt. The core preferably serves as the ink source, i.e., a carrier for the ink. According to particular embodiments, the composition is contained inside a marker, and a lower viscosity (e.g., between about 2 cP to about 4.5 cP) helps promote wicking through a porous marker nib. Preferably, the permanent marking system further includes one or more brushes that can be used to apply the fixing treatment composition to a substrate.

In a yet another aspect, the present invention is directed to a method of making the fixing treatment composition of the present invention. According to certain embodiments, the ingredients of the fixing treatment composition can be mixed together in any order. The method is preferably carried out at room temperature (e.g., at about 20 degrees Celsius to about 30 degrees Celsius, or about 25 degrees Celsius) and without adding any heat to the composition. However, heat may optionally be applied to the composition during one or more method steps. In each step, after each component is added, the solution is thoroughly mixed.

In certain embodiments, the method includes the following steps: (a) adding one or more film formers to one or more acrylic binders to form a mixture; (b) subsequently adding one or more diluents to the mixture; and (c) subsequently adding one or more rheology modifiers to the mixture. Exemplary film formers, diluents, and rheology modifiers are discussed above in connection with the fixing treatment composition of the present invention. One or more additives may be added either prior to or subsequent to any of the steps of (a)-(c). In certain embodiments, the additives are added subsequent steps (a)-(c). The one or more additives include, but are not necessarily limited to, one or more rheology modifiers, one or more stain blockers, one or more surfactants, one or more tinting dyes, one or more preservatives, and glitter as discussed above in connection with the fixing treatment composition of the present invention.

In certain embodiments, the one or more film formers and the one or more diluents are each added in at least two separate portions that may—but need not necessarily—be equal to one another. In such embodiments, the method includes the following steps: (1) adding a first portion of one or more film formers to one or more acrylic binders to form a mixture; (2) subsequently adding a first portion of one or more diluents to the mixture; (3) subsequently adding a second portion of the one or more film formers to the mixture; and (4) subsequently adding a second portion of the one or more diluents to the mixture. One or more additives may be added either prior to or subsequent to any of the steps of (1)-(4). In certain embodiments, the additives are added subsequent steps (1)-(4). The one or more additives include, but are not necessarily limited to, one or more rheology modifiers, one or more stain blockers, one or more surfactants, one or more tinting dyes, one or more preservatives, and glitter as discussed above in connection with the fixing treatment composition of the present invention.

An exemplary and non-limiting method of preparing the formulation of the fixing treatment composition shown in Table 2 is set forth below:

TABLE 2
Fixing Treatment Composition

| Portion | Ingredient Name | wt % |
|---|---|---|
| A | NEOCAR ® ACRYLIC 820 | 77 |
| B | Selvol ™ Polyvinyl Alcohol 09-523 Solution | 5 |
| C | Propylene Glycol | 5 |
| D | Selvol ™ Polyvinyl Alcohol 09-523 Solution | 5 |
| E | Propylene Glycol | 5 |
| F | SC 6477, ACRYSOL ™ RM-2020 | 3 |
| Total | | 100 |

Portion A was added to a container and was mixed with a mixer at a constant speed. Next, Portion B was slowly mixed into Portion A to create a mixture, while increasing the mixing speed to ensure a vortex is created. Adding Portion B into Portion A increased the viscosity of the mixture drastically. Portion C was then subsequently and promptly mixed into the mixture to stabilize the viscosity of the mixture. Next, Portion D was subsequently and slowly mixed into the mixture. Portion E was then subsequently and promptly added to the mixture to again stabilize the viscosity of the mixture. Portion F was then subsequently added, and the speed of the mixer was increased. The mixture was then mixed for approximately five minutes. The mixture was not allowed to gain heat during any of the steps.

In yet one more aspect, the present invention is directed to a method of permanently affixing one or more inks to a substrate with a fixing treatment composition. Preferably, the one or more inks are at least partially rinsable, at least partially washable, or combinations thereof. More preferably, the one or more inks are rinsable, washable, or combinations thereof. Preferably, the fixing treatment composition of the present invention is used with the method. Preferably, the method is performed with the permanent marking system of the present invention. The method can be used to customize substrates with one or more designs. The substrates are preferably fabric and more preferably cotton fabric.

In essence, the fixing treatment composition is used to coat and “lock in” (i.e., make permanent) one or more elements of designs that are created on substrates with ink that is at least partially rinsable and/or at least partially washable; in effect, any ink on the substrate that comes into contact with the fixing treatment composition will ultimately become locked into place. The fixing treatment composition is selectively applied only to designs and/or elements of designs that a user desires to be permanently affixed to a given substrate.

Although the fixing treatment composition of the present invention is preferred, any composition that can be used to coat and “lock in” (i.e., make permanent) one or more elements of designs that are created on substrates may be a suitable fixing treatment composition for use with this method. Accordingly, although the method is described herein in connection with the fixing treatment composition/permanency gel of the present invention, it should be understood that the method may be performed with other compositions that may perform the same or a similar function.

The method includes the following steps: applying the one or more inks to a portion of the substrate to create a design; and applying the fixing treatment composition (e.g., permanency gel) to one or more elements of the design that a user desires to lock in. Preferably, the one or more inks used to create the design are allowed to dry completely before applying the permanency gel to the one or more elements of the design a user desires to lock in. Preferably, the permanency gel is generously applied to the one or more elements of the design a user wishes to lock in; in fact, in certain embodiments, the permanency gel will appear white once initially applied and will eventually dry clear. At the same time—in order to avoid locking in undesirable design elements and/or to prevent color run/bleeding—the permanency gel is preferably not applied to other portions of the substrate that do not include one or more elements of the design a user wishes to lock in.

Preferably, one or more tools can be used during the application of the permanency gel to reduce the risk of color run/bleeding to undesirable portions of the substrate. For example, a protective layer or barrier may be positioned between adjacent layers of the substrate during the application of the permanency gel. This can be done, for example, when applying the permanency gel to portions of a design on the front of a t-shirt. A protective layer or barrier (e.g., cardboard, card stock, newspaper, etc.) may be placed between the fabric of the front of the t-shirt and the fabric of the back of the t-shirt. As another example, tools including but not limited to masking tools, rulers, stencils, and tape may be used to prevent certain portions of the substrate from coming into contact with the permanency gel. Preferably, any tools used are promptly removed following the application of the permanency gel to prevent them from adhering to the substrate.

Preferably, the permanency gel is applied with one or more brushes. Preferably—in order to avoid color run/bleeding—each brush is thoroughly washed after being used to apply the permanency gel to design elements of a given color and prior to any subsequent use of each brush to apply the permanency gel to design elements of another, different color. Preferably, each brush is also washed thoroughly in between uses for best long term care results.

Following the application of the permanency gel to the substrate, it is preferable to allow the portions of the substrate coated or treated with the permanency gel to dry completely such that they feel dry to the touch. Preferably, they are allowed to air dry for about 24 hours. After the portions of the substrate treated with the permanency gel are dry to the touch, the substrate is preferably heat treated in order to heat set the permanency gel. This can be done, for example, by drying the substrate in a standard clothes dryer at a temperature of preferably about 125 degrees Fahrenheit to about 180 degrees Fahrenheit, more preferably about 125 degrees Fahrenheit to about 150 degrees Fahrenheit, and most preferably about 125 degrees Fahrenheit to about 135 degrees Fahrenheit. Generally speaking, the “Normal” setting of most residential clothes dryers is sufficient. The substrate should be heat treated for preferably about 20-60 minutes, more preferably about 30-50 minutes, and most preferably for about 40 minutes.

Following heat treatment, some portions of the substrate that were treated with the permanency gel may feel stiff to the touch. If this occurs, those portions may be further heat treated with a clothes iron until they are no longer stiff. Preferably, a piece of parchment paper is positioned between the iron and the portions of the substrate that were coated with the permanency gel. This is done for preferably about 10-40 seconds, more preferably about 15-30 seconds, and most preferably about 20-25 seconds.

Following heat treatment, the substrate is preferably washed in a standard washing machine to remove any ink that was not coated with the fixing treatment composition. The temperature of the water may be cold, warm, or hot, and the textile setting is preferably set to “Normal.” After the substrate is washed, it is preferably dried in a standard dryer at any suitable heat setting until fully dry. The washing step can be repeated as necessary to remove rinsable and/or washable ink from the substrate that was not treated with the permanency gel and that did not completely wash out after one or more washes.

In certain embodiments where the permanency gel used to permanently affix one or more inks to a substrate contains glitter, glitter will become permanently affixed to portions of the substrate that are coated with the permanency gel, thereby creating a decorative, sparkling effect.

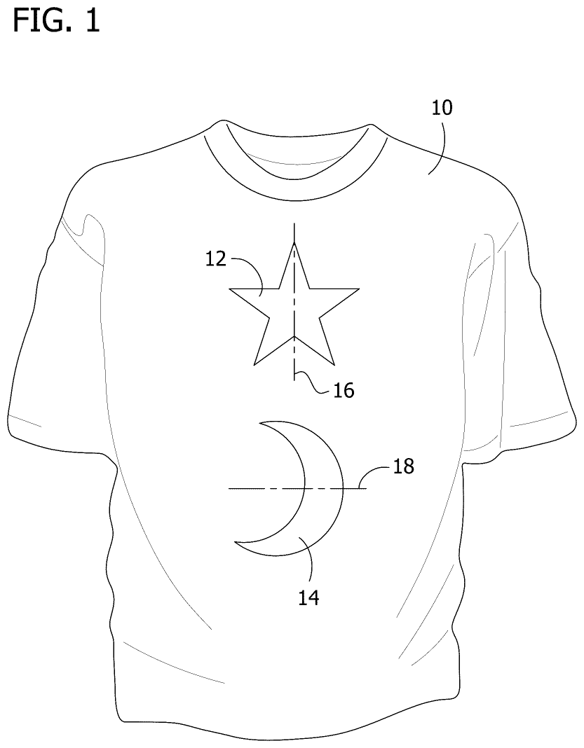

Exemplary and non-limiting methods of permanently affixing one or more inks to a substrate with the permanency gel of the invention are described below with reference to FIGS. 1-7.

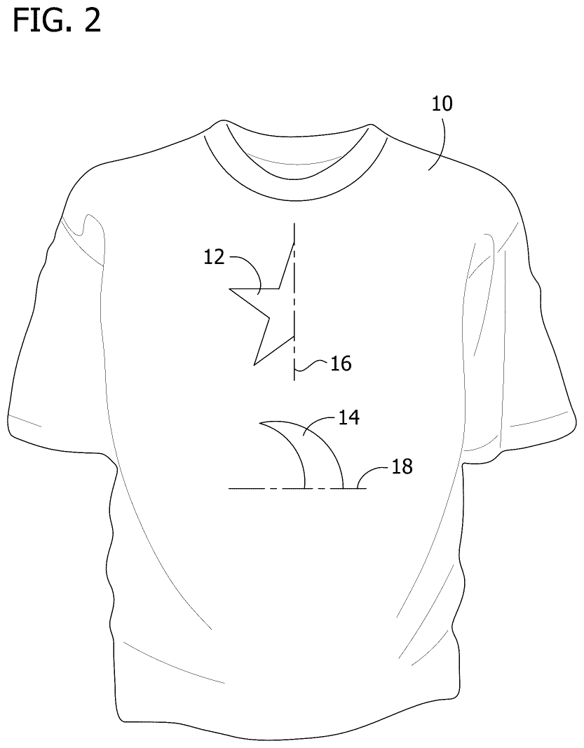

Referring to FIG. 1, a star design 12 and a crescent moon design 14 are depicted on the front of a t-shirt 10. Each of the designs 12, 14 were created with ink that is rinsable and/or washable. An axis 16 bisects the star design 12, and an axis 18 bisects the crescent moon design 14. Each of the designs 12, 14 were allowed to air dry until dry to the touch. Subsequently, permanency gel was applied to the portion of the star design 12 to the left of axis 16. However, permanency gel was not applied to the portion of the star design 12 to the right of axis 16. Similarly, permanency gel was applied to the portion of the crescent moon design 14 above axis 18. However, permanency gel was not applied to the portion the crescent moon design 14 below axis 18. T-shirt 10 was then allowed to air dry until the portions of designs 12, 14 that were coated with the permanency gel were dry to the touch. T-shirt 10 was then dried in a standard dryer for about 40 minutes on “Normal” to heat set the portions of the design coated with the permanency gel. T-shirt xx was then washed in a standard washing machine in cold water and subsequently dried in a standard dryer. As shown in FIG. 2, the portions of designs 12, 14 that were not coated with the permanency gel washed out completely after just one wash. On the other hand, the portions of designs 12, 14 that were coated with the permanency gel remained intact and permanently affixed to t-shirt 10.

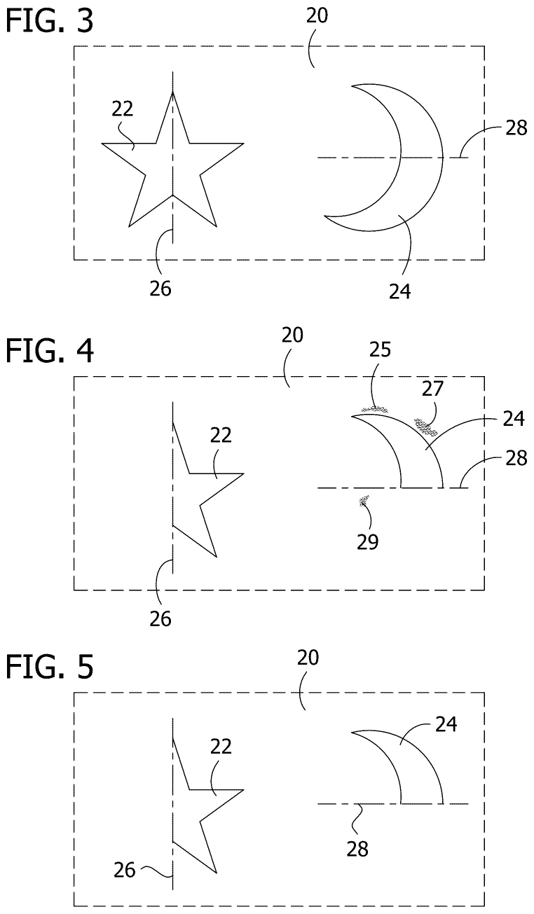

Referring to FIG. 3, a star design 22 and a crescent moon design 24 are depicted on the front of t-shirt 20. Each of the designs 22, 24 were created with ink that is at least partially rinsable and/or at least partially washable. An axis 26 bisects the star design 22, and an axis 28 bisects the crescent moon design. Each of the designs 22, 24 were allowed to air dry until dry to the touch. Subsequently, permanency gel was applied to the portion of the star design 22 to the right of axis 26. However, permanency gel was not applied to the portion of the star design 22 to the left of axis 26. Similarly, permanency gel was applied to the portion of the crescent moon design 24 above axis 28. However, permanency gel was not applied to the portion the crescent moon design 24 below axis 28. T-shirt 20 was then allowed to air dry until the portions of designs 22, 24 that were coated with the permanency gel were dry to the touch. T-shirt 20 was then dried in a standard dryer for about 40 minutes on “Normal” to heat set the portions of the design coated with the permanency gel. T-shirt 20 was then washed in a standard washing machine in hot water and subsequently dried in a standard dryer. As shown in FIG. 4, after the first wash, some of the rinsable and/or washable ink that was not covered with permanency gel ran and/or bled, thereby creating stained sections 25, 27, and 29 of t-shirt 20. For the most part, however, the portions of designs 22, 24 that were not coated with the permanency gel washed out completely. On the other hand, the portions of designs 22, 24 that were coated with the permanency gel remained intact and permanently affixed to t-shirt 20. As shown in FIG. 5, after the second washing of t-shirt 20 in hot water, the stained sections 25, 27, and 29 washed out completely. At the same time, the portions of designs 22, 24 that were coated with the permanency gel continued to remain intact and permanently affixed to t-shirt 20.

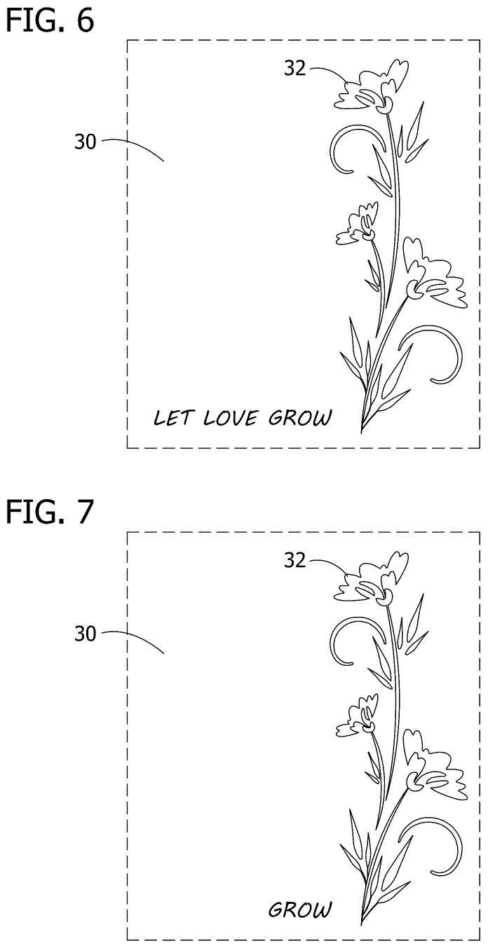

Referring to FIG. 6, a flower design 32 and the words “LET LOVE GROW” are depicted on the front of t-shirt 30. The design and words were created with stencils and were allowed to air dry until dry to the touch. Subsequently, permanency gel was applied to all portions of flower design 32 and to the word “GROW” utilizing the same stencils that were used to create design xx and the words “LET LOVE GROW”. However, permanency gel was not applied to the words “LET LOVE”. T-shirt 30 was then allowed to air dry until the portions coated with the permanency gel were dry to the touch. T-shirt 30 was then dried in a standard dryer for about 40 minutes on “Normal” to heat set the portions of the design coated with the permanency gel. T-shirt 30 was then washed in a standard washing machine in hot water and subsequently dried in a standard dryer. As shown in FIG. 7, after the first wash, the words “LET LOVE”, which were not coated with permanency gel, washed out completely. On the other hand, flower design 32 and the word “GROW” were coated with the permanency gel remain intact and permanently affixed to t-shirt 30.

An exemplary permanent marking system (“permanent marking system 1”), comprising:
the fixing treatment composition of the present invention; and
one or more inks, wherein the one or more inks are selected from the group consisting of at least partially rinsable, at least partially washable, and combinations thereof.

Permanent marking system 1, further comprising one or more brushes.

An exemplary method of making the fixing treatment composition of the present invention (“exemplary method 1”), comprising:
(a) adding a first portion of the one or more film formers to the one or more acrylic binders to form a mixture; and
(b) subsequently adding a first portion of the one or more diluents to the mixture.

Exemplary method 1, further comprising:
(c) subsequently adding a second portion of the one or more film formers to the mixture; and
(d) subsequently adding a second portion of the one or more diluents to the mixture.

Exemplary method 1, further comprising:
(e) adding one or more rheology modifiers to the mixture.

Exemplary method 1, further comprising:
(f) adding one or more stain blockers to the mixture.

Exemplary method 1, further comprising:
(g) adding one or more surfactants to the mixture.

A method of permanently affixing one or more inks to a substrate (“exemplary method 2”), comprising:
applying the one or more inks to a portion of the substrate, wherein the one or more inks are selected from the group consisting of at least partially rinsable, at least partially washable, and combinations thereof; and
applying a fixing treatment composition to the portion of the substrate.

Exemplary method 2, further comprising allowing the portion of the substrate to air dry (“exemplary method 3”).

Exemplary method 3, further comprising heating the portion of the substrate with a dryer (“exemplary method 4”).

Exemplary method 4, further comprising ironing the portion of the substrate.

A method of permanently affixing one or more inks to a substrate (“Exemplary method 5”), comprising:
applying the one or more inks to a portion of the substrate, wherein the one or more inks are selected from the group consisting of at least partially rinsable, at least partially washable, and combinations thereof; and
applying the fixing treatment composition of the present invention to the portion of the substrate.

Exemplary method 5, further comprising allowing the portion of the substrate to air dry (“exemplary method 6”).

Exemplary method 6, further comprising heating the portion of the substrate with a dryer (“exemplary method 7”).

Exemplary method 7, further comprising ironing the portion of the substrate.

A method of permanently affixing one or more inks to a substrate with permanent marking system 1 (“exemplary method 8”), comprising:
applying the one or more inks to a portion of the substrate; and
applying the fixing treatment composition to the portion of the substrate.

Exemplary method 8, further comprising allowing the portion of the substrate to air dry (“exemplary method 9”).

Exemplary method 9, further comprising heating the portion of the substrate with a dryer (“exemplary method 10”).

Exemplary method 10, further comprising ironing the portion of the substrate.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A fixing treatment composition comprising:
one or more acrylic binders;
one or more film formers; and
one or more diluents.

2. The fixing treatment composition of claim 1, further comprising one or more rheology modifiers.

3. The fixing treatment composition of claim 1, further comprising one or more stain blockers.

4. The fixing treatment composition of claim 1, further comprising one or more surfactants.

5. The fixing treatment composition of claim 1, further comprising one or more tinting dyes.

6. The fixing treatment composition of claim 1, further comprising one or more preservatives.

7. The fixing treatment composition of claim 1, comprising:
about 60 wt % to about 85 wt % of the one or more acrylic binders;
about 2.5 wt % to about 15 wt % of the one or more film formers; and
about 5 wt % to about 15 wt % of the one or more diluents.

8. The fixing treatment composition of claim 7, further comprising about 0.5 wt % to about 5 wt % of the one or more rheology modifiers.

9. The fixing treatment composition of claim 7, further comprising about 1 wt % to about 10 wt % of the one or more stain blockers.

10. The fixing treatment composition of claim 7, further comprising about 3 wt % or less of the one or more surfactants.

11. The fixing treatment composition of claim 7, further comprising one or more tinting dyes.

12. The fixing treatment composition of claim 7, further comprising one or more preservatives.

13. The fixing treatment composition of claim 1, wherein the one or more acrylic binders are one or more aqueous emulsion acrylic polymers.

14. The fixing treatment composition of claim 13, wherein the one or more aqueous emulsion acrylic polymers are selected from the group consisting of JONCRYL® 646 (supplied by BASF), SC 6569 (supplied by StanChem), RHOPLEX™ AC-464 Emulsion Polymer (supplied by Dow Chemical), RHOPLEX™ AC-261LF Emulsion Polymer (supplied by Dow Chemical), ENCORE® 636 (supplied by Arkema) NEOCAR® ACRYLIC 820 (supplied by Arkema), DI18031-07 (supplied by Zschimmer & Schwarz), and combinations thereof.

15. The fixing treatment composition of claim 1, wherein the one or more film formers are selected from the group consisting of polyethylene glycol, polyvinyl pyrrolidone (PVP), polyvinyl acetate (PVA), ethylene-vinyl alcohol copolymer (EVOH), polyvinyl alcohol (PVOH), and combinations thereof.

16. The fixing treatment composition of claim 15, wherein the one or more film formers are one or more polyvinyl alcohols.

17. The fixing treatment composition of claim 16, wherein the one or more polyvinyl alcohols are selected from the group consisting of hydrolyzed polyvinyl alcohols, partially hydrolyzed polyvinyl alcohols, and combinations thereof.

18. The fixing treatment composition of claim 17, wherein the one or more polyvinyl alcohols are partially hydrolyzed polyvinyl alcohols.

19. The fixing treatment composition of claim 18, wherein the one or more partially hydrolyzed polyvinyl alcohol is Selvol™ Polyvinyl Alcohol 09-523 Solution (supplied by Sekisui Special Chemicals).

20. The fixing treatment composition of claim 1, wherein the one or more diluents are selected from the group consisting of propylene glycol, glycerin, propylene carbonate, ethylene glycol, diethylene glycol, triethylene glycol, and combinations thereof.

21. The fixing treatment composition of claim 20, wherein the one or more diluents are propylene glycol.

22. The fixing treatment composition of claim 2, wherein the one or more rheology modifiers are selected from the group consisting of inorganic, organic, non-ionic associative thickeners, anionic associative thickeners, non-associative thickeners, and combinations thereof.

23. The fixing treatment composition of claim 2, wherein the one or more rheology modifiers are selected from the group consisting of SC 6477 (supplied by StanChem), ACRYSOL™ RM-2020 (supplied by Dow Chemical), and combinations thereof.

24. The fixing treatment composition of claim 3, wherein the one or more stain blockers are selected from the group consisting of sodium octane sulfonate, sodium xylene sulfonate, fatty alcohol ethoxylate, disodium hexadecyldiphenyloxide disulfonate, benzene-1,1-oxybis-tetrapropylene sulfonated sodium, decyl-sulfophenoxy-benzenesulfonic acid-disodium, decyl-sulfophenoxybenzenesulfonic acid disodium, octylphenoxypolyethoxyethanol, sodium salt of naphthalene-formaldehyde condensation polymer, sodium salt of carboxylated polyelectrolytes, sodium lignin sulfonate, styrene maleic anhydride copolymers, Durablock SB (supplied by DURA Chemicals), and combinations thereof.

25. The fixing treatment composition of claim 4, wherein the one or more surfactants are selected from the group consisting of acetylenic diols, acetylenic diol ethoxylates, alkylphenol ethoxylates, and combinations thereof.

26. The fixing treatment composition of claim 25, wherein the one or more surfactants are acetylenic diols.
